(19) United States
(12) Patent Application Publication
(10) Pub. No.: US 2006/0291758 A1
(43) Pub. Date: Dec. 28, 2006

(54) Shaft assembly for motor

(75) Inventors: Alex Hong, Kaohsiung City (TW); Ching-Shen Hong, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/222,753

(22) Filed: Sep. 12, 2005

(30) Foreign Application Priority Data
Jun. 23, 2005 (TW) 094120921

(51) Int. Cl. F16C 33/76; F16C 32/06

(52) U.S. Cl. 384/107

(57) ABSTRACT

The invention relates to a shaft assembly for a motor. The shaft assembly comprises: a shaft tube, a bearing, a shaft and at least two engaged rings. The shaft has an end and a slot. At least two engaged rings are disposed in the slot of the shaft, and comprise a first engaged ring and a second engaged ring. The first engaged ring is a metal material and the second engaged ring is a non-metal material. The material strength of the first engaged ring is larger than that of the second engaged ring. The first engaged ring can be utilized to support and position the shaft, and the second engaged ring can be utilized to cushion the shaft. Therefore, the problems of motor noise, rotor shift or even separating from the bearing can be resolved simultaneously so as to increase the stability of motor.

### BACKGROUND OF THE INVENTION

1. Field of the Invention

The present invention relates to a motor. In particular, the present invention relates to a shaft assembly for a motor.

2. Description of Related Art

Referring to FIG. 1, it shows a conventional rotor structure disclosed in Taiwan Application No. 088219447, entitled “rotor structure for small motor”. The conventional rotor structure comprises: a metal shaft tube 3, a bearing 32 and a rotor 4. The metal shaft tube 3 is mounted on a base 1. A stator 2 is mounted on the metal shaft tube 3. The bearing 32 is mounted in the metal shaft tube 3. The rotor 4 has a shaft 41 penetrating through the bearing 32. An engaged element 43 is used to position the shaft 41 so that the rotor 4 can rotate corresponding to the stator 2 to prevent the problem of separating the shaft 41 from the bearing 32.

The engaged element 43 is a metal engaged ring. The metal engaged ring can provide enough strength to support the shaft 41 so as to prevent the problem of separating the shaft 41 from the bearing 32. However, the shaft 41 is also a metal material, and the corresponding rotation and vibration between the shaft 41 and the engaged element 43 can easily produce the mechanical noise and wearing problem.

Furthermore, referring to FIG. 2, it shows a second conventional rotor structure using a Mylar ring. The Mylar ring 44 has better elasticity to provide cushion and absorb the vibration of the shaft 41 so as to prevent the mechanic noise. However, when the motor is struck or vibrated, the Mylar 44 may be deformed by the struck force so that the shaft 41 can not be positioned or the shaft 41 may shift or even separate from the bearing 32. Therefore, it is needed to solve the above problems

### SUMMARY OF THE INVENTION

An object of the present invention is to provide a shaft assembly for a motor. The shaft assembly comprises: a shaft tube, a bearing, a shaft and at least two engaged rings. The shaft tube is mounted on a base. The bearing is mounted in the shaft tube. The shaft is mounted in the bearing and can rotate, and the shaft has an end and a slot. At least two engaged rings are disposed in the slot of the shaft, and two engaged rings comprise a first engaged ring and a second engaged ring. The first engaged ring is a metal material and the second engaged ring is a non-metal material. The material strength of the first engaged ring is larger than that of the second engaged ring. Because the two engaged rings are different materials, the first engaged ring can be utilized to support and position the shaft, and the second engaged ring can be utilized to cushion the shaft. Therefore, the problems of motor noise, rotor shift or even separating from the bearing can be resolved simultaneously so as to increase the stability of motor.

### BRIEF DESCRIPTION OF THE DRAWINGS

FIG. 1 is a sectional view of a first conventional rotor structure;

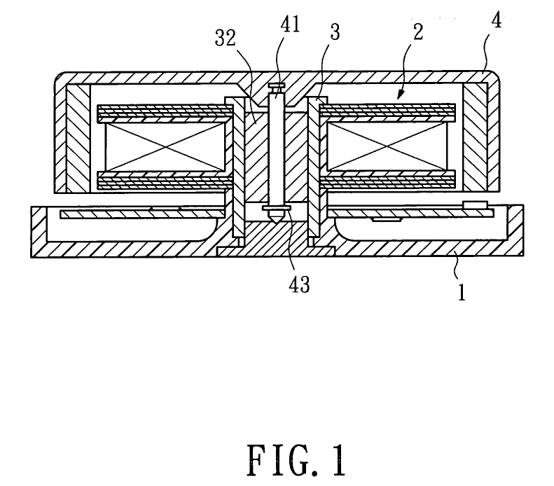

FIG. 2 is a sectional view of a second conventional rotor structure using a Mylar ring;

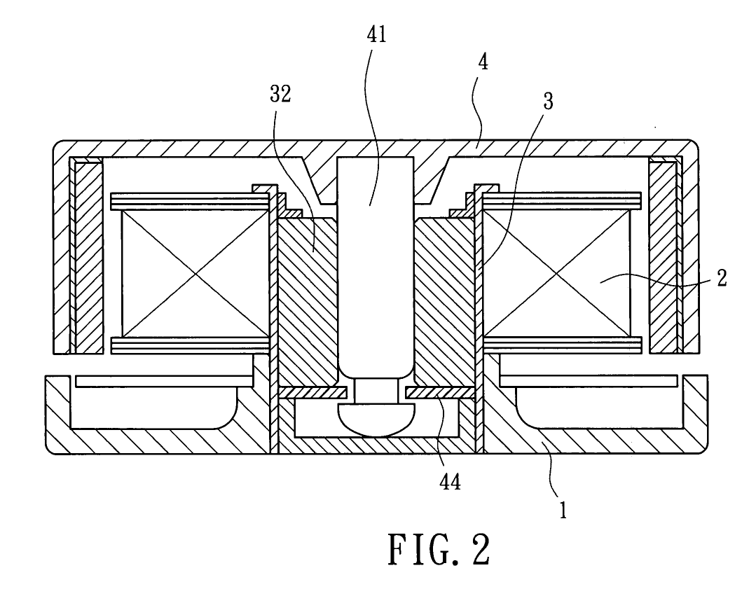

FIG. 3 is a sectional view of a shaft assembly, according to a first embodiment of the present invention; and

FIG. 4 is a sectional view of a shaft assembly, according to a second embodiment of the present invention.

### DETAILED DESCRIPTION OF THE PREFERRED EMBODIMENTS

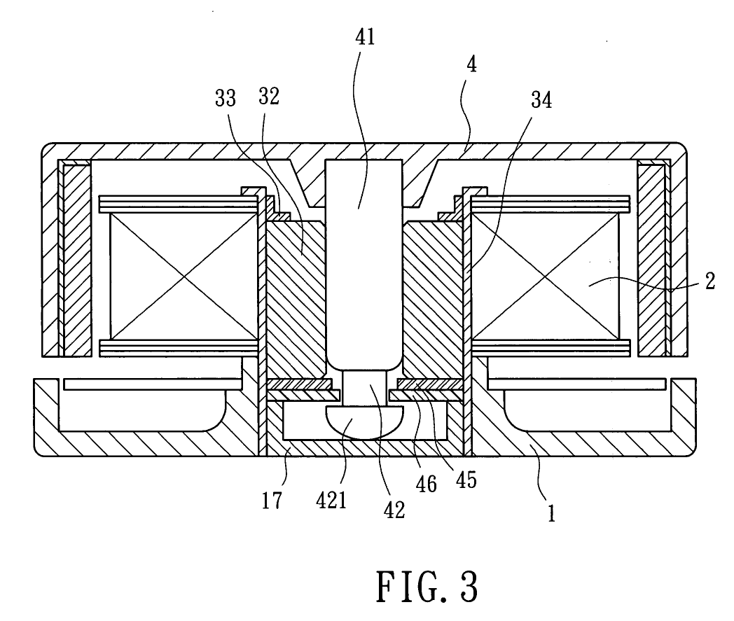

Referring to FIG. 3, according to a first embodiment of the present invention, it shows a shaft assembly for a motor. The shaft assembly comprises: a shaft tube 34, a bearing 32, a shaft 41 and at least two engaged rings 45 and 46. The shaft tube 34 is mounted on a base 1. Besides, the shaft tube 34 and the base 1 may be manufactured integrally. A stator 2 is mounted on the shaft tube 34. The bearing 32 is mounted in the shaft tube 34. A rotor 4 has the shaft 41 penetrating through the bearing 32. The shaft 41 is mounted in the bearing 32 and can rotate, and the shaft 41 has an end 421 and a slot 42. The slot 42 is adjacent to the end 421, and the diameter of the slot 42 is smaller than that of the shaft 41.

The bearing 32 is fixed on a predetermined position by a position ring 33 and a cover 17. At least two engaged rings are disposed in the slot 42 of the shaft 41, and are disposed between the bearing 32 and the cover 17. The two engaged rings comprise a first engaged ring 45 and a second engaged ring 46.

The first engaged ring 45 is a metal material, and is disposed between the bearing 32 and the second engaged ring 46. The second engaged ring 46 is a non-metal material, and is disposed between the first engaged ring 45 and the end 421. The second engaged ring 46 can be a polymer material or its compound materials. The material strength of the first engaged ring 45 is larger than that of the second engaged ring 46. Furthermore, the inner diameter of the first engaged ring 45 is larger than or is equal to that of the second engaged ring 46.

Because the two rings 45 and 46 are different materials, the first engaged ring 45 can be utilized to support and position the shaft 41 so as to prevent the problem of separating the shaft 41 from the bearing 32, and the second engaged ring 46 can be utilized to cushion the shaft 41 so as to prevent the rotation noise.

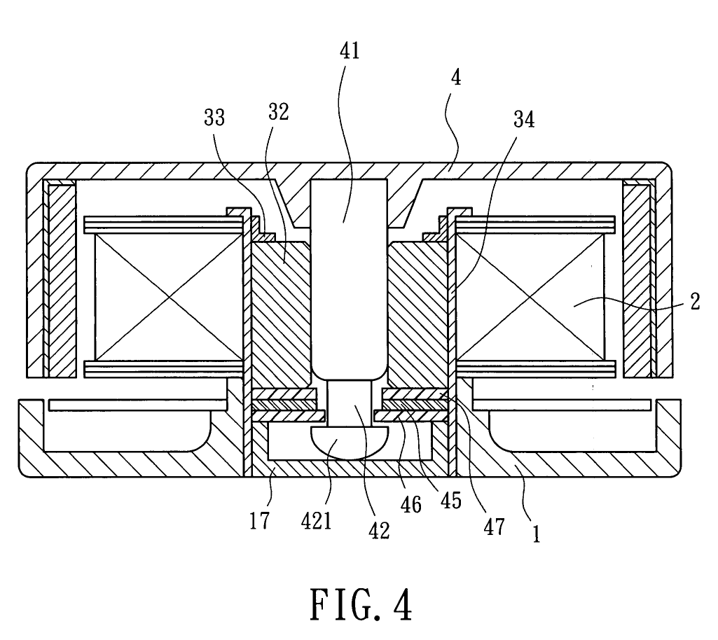

Referring to FIG. 4, according to a second embodiment of the present invention, it shows a shaft assembly for a motor. The shaft assembly further comprises a third engaged ring 47 disposed between the first engaged ring 45 and the bearing 32. That is, there are three engaged rings 45, 46, 47 disposed between the bearing 32 and the cover 17. The first engaged ring 45, the second engaged ring 46 and the third engaged ring 47 are disposed in the slot 42 of the shaft 41.

The first engaged ring 45 is a metal material, and the second engaged ring 46 and the third engaged ring 47 are non-metal material. The third engaged ring 47 is disposed on the first engaged ring 45, and the second engaged ring 46 is disposed under the first engaged ring 45. The second engaged ring 46 and the third engaged ring 47 can be polymer material or its compound materials. The material strength of the first engaged ring 45 is larger than that of the second engaged ring 46 and the third engaged ring 47. Furthermore, the inner diameter of the third engaged ring 47 is larger than or is equal to that of the second engaged ring 46. That is, the inner diameter of the third engaged ring 47 is equal to that of the first engaged ring 45.

Therefore, the first engaged ring 45 can be utilized to support and position the shaft 41 to prevent the shaft 41 from separating the bearing 32, and the second engaged ring 46 and the third engaged ring 47 can be utilized to cushion the shaft 41 to prevent the rotation noise. By utilizing the shaft assembly of the invention, the problems of motor noise, rotor shift or even separating from the bearing can be resolved simultaneously so as to increase the stability of motor.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A shaft assembly for a motor, the shaft assembly comprising:
a shaft tube, mounted on a base;
a bearing, mounted in the shaft tube;
a shaft, mounted in the bearing and being able to rotate, the shaft having an end and a slot; and
at least two engaged rings, disposed in the slot of the shaft, two engaged rings having a first engaged ring and a second engaged ring, the material strength of the first engaged ring being larger than that of the second engaged ring.

2. The shaft assembly as claimed in claim 1, wherein the first engaged ring is disposed between the bearing and the second engaged ring.

3. The shaft assembly as claimed in claim 1, wherein the second engaged ring is disposed between the end of the shaft and the first engaged ring.

4. The shaft assembly as claimed in claim 1, wherein the inner diameter of the first engaged ring is larger than or is equal to that of the second engaged ring.

5. The shaft assembly as claimed in claim 1, further comprising a third engaged ring disposed between the first engaged ring and the bearing.

6. The shaft assembly as claimed in claim 5, wherein the material strength of the first engaged ring is larger than that of the third engaged ring.

7. The shaft assembly as claimed in claim 5, wherein the material strength of the third engaged ring is equal to that of the second engaged ring.

8. The shaft assembly as claimed in claim 5, wherein the inner diameter of the third engaged ring is equal to that of the first engaged ring.

9. A shaft assembly for a motor, the shaft assembly comprising:
a shaft tube, mounted on a base;
a bearing, mounted in the shaft tube;
a shaft, mounted in the bearing and being able to rotate, the shaft having an end and a slot; and
at least two engaged rings, disposed in the slot of the shaft, two engaged rings having a first engaged ring and a second engaged ring, the first engaged ring being a metal material and the second engaged ring being a non-metal material.

10. The shaft assembly as claimed in claim 9, wherein the second engaged ring is a polymer material or its compound material.

11. The shaft assembly as claimed in claim 9, wherein the first engaged ring is disposed between the bearing and the second engaged ring.

12. The shaft assembly as claimed in claim 9, wherein the second engaged ring is disposed between the end of the shaft and the first engaged ring.

13. The shaft assembly as claimed in claim 9, wherein the inner diameter of the first engaged ring is larger than or is equal to that of the second engaged ring.

14. The shaft assembly as claimed in claim 9, further comprising a third engaged ring disposed between the first engaged ring and the bearing.

15. The shaft assembly as claimed in claim 14, wherein the material of the third engaged ring is the same as that of the second engaged ring.

16. The shaft assembly as claimed in claim 14, wherein the inner diameter of the third engaged ring is equal to that of the first engaged ring.
